(19) United States
(12) Patent Application Publication
(10) Pub. No.: US 2017/0115489 A1
(43) Pub. Date: Apr. 27, 2017

(54) HEAD MOUNTED DISPLAY DEVICE WITH MULTIPLE SEGMENT DISPLAY AND OPTICS

(71) Applicants: Xinda HU, Sunnyvale, CA (US); Jerry CAROLLO, San Francisco, CA (US)

(72) Inventors: Xinda HU, Sunnyvale, CA (US); Jerry CAROLLO, San Francisco, CA (US)

(21) Appl. No.: 14/923,144

(22) Filed: Oct. 26, 2015

(51) Int. Cl. G02B 27/01; H04N 13/04; G06T 19/00; G06T 3/00

(52) U.S. Cl. CPC G02B 27/0172; G06T 3/0093; H04N 13/0429; G06T 19/006; G02B 2027/0134; G02B 2027/0123; G02B 2027/011; G02B 2027/014; G02B 2027/0178

(57) ABSTRACT

A head mounted display (HMD) device includes first and second display panels laterally disposed about a medial plane. Each of the first and second curved display panels includes a first lateral section and an adjacent second lateral section. The first lateral section is adjacent to the medial plane and has a curvature with a first radius and the second lateral section is distal from the medial plane. The HMD further includes an optics assembly having first and second optics subassemblies disposed about the medial plane. Each of the first and second optics subassemblies includes a first optical element having an optical axis that intersects the first lateral section of a corresponding one of the first and second display panels and a second optical element having an optical axis that intersects the second lateral section of the corresponding one of the first and second display panels.

### BACKGROUND

Field of the Disclosure

The present disclosure relates generally to display devices and, more particularly, to head mounted display devices.

Description of the Related Art

Immersive virtual reality (VR) and augmented reality (AR) systems typically utilize a head mounted display (HMD) device that presents stereoscopic imagery to the user so as to give a sense of presence in a three-dimensional (3D) scene. Most conventional HMD devices implement either a single flat display that is separated into two independent display regions, one for the left eye and one for the right eye of the user, or a pair of independent flat displays, one for each eye of the user. Such devices also typically include a single lens for each eye so as to focus the entire image of the display into the user's eye. However, the use of flat displays and a single lens for each eye often results in a bulky HMD form factor, which in turn imparts a high moment of inertia when in use. Moreover, the flat displays and lenses constrain the total lateral field of view, often to 110 degrees or less. The bulky size and limited field of view of these conventional HMD devices can deleteriously impact the user's sense of presence in the displayed image and thus inhibit the feeling of being immersed in the presented scene.

Various solutions have been proposed to address these shortcomings. In some approaches, the display system is separated into a set of separate display panels that are tiled together to obtain a larger field of view. However, under this approach, the physical seams between the optics and between the display panels are often noticeable and thus detract from the experience. Moreover, the characteristics of each display panel may differ, and thus render it difficult to achieve uniform color and brightness across the entire field of view. Additionally, the design and fabrication of such systems is complex and thus can be cost-prohibitive.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is diagram illustrating a rear perspective view of a head mounted display (HMD) device utilizing display panels with logical tiling and a corresponding lens assembly in accordance with at least one embodiment of the present disclosure.

FIG. 2 is diagram illustrating a cross-section view of one embodiment of the HMD device of FIG. 1 in accordance with some embodiments.

FIG. 3 is diagram illustrating a left side of the cross-section view of FIG. 2 in greater detail in accordance with some embodiments.

FIG. 4 is diagram illustrating a left side of a cross-section view of another embodiment of the HMD device of FIG. 1 in accordance with some embodiments.

FIG. 5 is diagram illustrating a left side of a cross-section view of another embodiment of the HMD device of FIG. 1 in accordance with some embodiments.

FIG. 6 is a diagram illustrating an electronic display system of the HMD device of FIG. 1 in accordance with some embodiments.

FIG. 7 is a diagram illustrating a process for pre-warping an image generated for display at a display panel of the HMD device of FIG. 1 in accordance with some embodiments.

### DETAILED DESCRIPTION

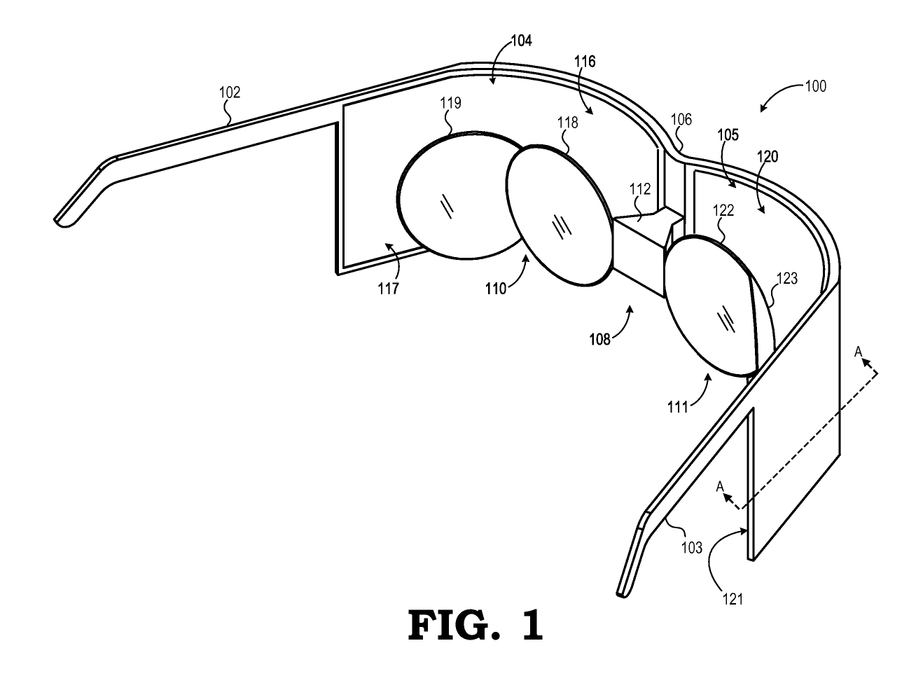

FIGS. 1-7 illustrate examples of an HMD device that utilizes two display panels, one for each eye, and a corresponding set of optic element sub-assemblies to enable a small form factor and wider lateral field of view. In at least one embodiment, the HMD device comprises a pair of laterally-curved display panels, one for each of the user's eyes, and an optical assembly comprising two optical sub-assemblies, one for each of the display panels. Each display panel may be independently driven by a separate display controller, and the display panels together may be operated to present a stereoscopic, or 3D, view of an AR or VR scene. Each display panel is logically divided in to two or more lateral sections, including a central field of view (FOV) section that is curved or substantially flat, and an adjacent peripheral field of view (FOV) section that may also may be curved or may be substantially flat. Each optical sub-assembly includes at least two lenses or other optical elements, including an optical element focused on the central FOV section (that is, having an optical axis that intersects the central FOV section) and another optical element focused on the peripheral FOV section (that is having an optical axis that intersects the peripheral FOV section). Each optical element may comprise a single optical lens or multiple optical lenses (such as, for example, a microlens array or other grouping of lenses). Due to immediate adjacency between the central FOV and peripheral FOV sections resulting from the central and peripheral FOV sections being logical divisions of the same display panel, in at least one embodiment the optical element focused on the peripheral FOV may be a laterally truncated optical element (that is, rotationally/axially asymmetric) so as to allow a more compact placement of both optical elements while reducing or minimizing the seam between the two optical elements. The use of a single display panel with sections having different curvatures and angles permits the implementation of an HMD device with a form factor that more closely conforms to the user's head compared to conventional HMD devices that utilize one or more flat display panels, while also providing a more uniform color and brightness across the field of view and a less complex display and optical assembly configuration compared to conventional HMD devices utilizing multiple separate optically or mechanically tiled display panels.

FIG. 1 illustrates a rear perspective view of an implementation of an HMD device 100 in accordance with at least one embodiment of the present disclosure. In the depicted example, the HMD device 100 has an “eyeglass” form factor in which the HMD device 100 is mounted to a user's face via temples 102, 103, which are positioned behind the user's ears when worn by the user. However, in other embodiments the HMD device 100 may be implemented with a “mask” form factor in which the HMD device 100 is mounted to the user's face via one or more straps or other attachment devices. Further, although omitted for ease of illustration, the HMD device 100 also may include one or more face gaskets to seal against the user's face for the purposes of limiting ambient light intrusion.

The HMD device 100 includes a pair of display panels 104, 105 mounted in a frame 106. The HMD device 100 further includes an optical assembly 108 mounted to the frame 106 (e.g., via the bridge of the frame 106). The optical assembly 108 includes a pair of optical subassemblies 110, 111, one for each eye of a user. The optical assembly 108 further includes a bridge structure 112 that includes a standoff structure that extends from a posterior surface of the frame 106, and thus offsetting the optical subassembly 110 from the face of the display panel 104 and offsetting the optical subassembly 111 from the face of the display panel 105. For example, the standoff structure may implement a vertical structure extending from the bridge of the frame 106 (as shown in FIG. 1), a horizontal structure extending from the horizontal top bar of the frame, and the like.

As shown in FIG. 1, each of the display panels 104, 105 comprises a continuous display panel with different lateral portions having differing degrees of curvature (or substantially no curvature), different orientations, or a combination thereof, such that each portion represents a separate logical section or “tile” of the display panel. That is, while each display panel comprises a set of pixel rows that extend across the entire lateral extent of the display panel (e.g., lateral extent 114 of display panel 104) and which are driven by the same display driver hardware, the display panel may be logically organized as a set of adjacent lateral sections based on changes in the curvature of the display panel in the section or based on the orientation of the section relative to the corresponding eye of the user. The curved display panels 104, 105 may be implemented using any of a variety of display technologies capable of providing a display panel with a varying curvature or orientation configuration, such as a thin-film flexible organic light emitting diode (OLED)-based display that is flexed into the desired curvatures and sectional orientations and maintained as such via a supporting frame. Further, the optical subassemblies 110, 111 each has a plurality of optical elements, with each optical element comprising one or more lenses and being focused on a corresponding section of the associated display panel. That is, the optical axis of each optical element (or optical axes if there is more than one lens in the optical element) intersects the face of a corresponding display panel section (referred to herein as a “display panel tile”), and in some embodiments, the optical axis is normal to the face of the corresponding display panel.

To illustrate, in the depicted embodiment the display panel 104 includes two lateral sections: a left central field of view (FOV) section 116 and a left peripheral FOV section 117, and the optical subassembly 110 is implemented with two lenses: a left central lens 118 focused on the left central FOV section 116 and a left peripheral lens 119 focused on the left peripheral FOV section 117. Similarly, in the depicted embodiment the display panel 105 includes two lateral sections: a right central field of view (FOV) section 120 and a right peripheral FOV section 121, and the optical subassembly 111 is implemented with two lenses: a right central lens 122 focused on the right central FOV section 120 and a right peripheral lens 123 focused on the right peripheral FOV section 121. The lenses 118, 119, 122, 123 are illustrated as convex substantially circular lenses. However, the lenses may be implemented in any of a variety of suitable shapes, such as rotationally symmetric or non-rotational symmetric (e.g., toroidal or freeform) lenses, Fresnel lenses, and the like. Further, while embodiments wherein lenses 118, 119, 122, 123 each comprise a single larger lens, in other embodiments one or more of lenses 118, 119, 122, and 123 may be implemented as a plurality of lenses. The lenses may be composed of any of a variety of materials or combinations of materials suitable for fabricating laterally-curved lenses, such as plastic, glass, crystal, and the like.

Through the use of display panel sections with different curvatures and/or orientations relative to the user's eye and optics subassemblies with separate lens elements focused on separate display panel sections accordingly, the HMD device 100 may be fabricated with a form factor that maintains the bulk of the HMD device 100 closer to the user's head, thereby reducing its moment of inertia as well as providing a wider lateral field of view and a more aesthetically pleasing appearance. Moreover, as each display panel section is not a separate display panel but rather is a logical sectioning of a larger display panel, a more uniform brightness and coloration is maintained between the display panel sections.

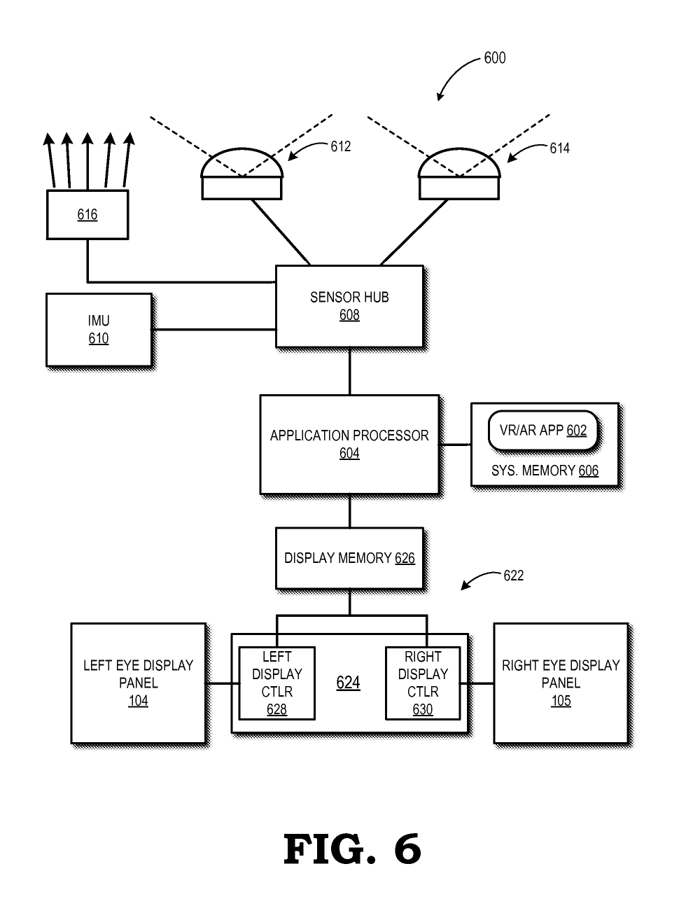

Although not shown in FIG. 1 for purposes of clarity, the HMD device 100 also may include a variety of imaging and non-imaging sensors to support the VR or AR functionality of the HMD device 100. For example, the HMD device 100 may include an inertial management unit (IMU) having one or more of a gyroscope, magnetometer, and accelerometer to support pose detection of the HMD device 100, one or more imaging sensors to capture imagery in support of AR functionality or in support of visual telemetry functionality, an infrared depth sensor to support visual telemetry functionality, and the like. Further, the HMD device 100 may include one or more wired or wireless interfaces (not shown) to permit the HMD device 100 to be connected to an external computing system via a wired or wireless link for the purposes of transmitting and receiving information, such as transmitting pose information to a computing system and receiving stereoscopic VR imagery for display based on the pose information. Examples of these sensor configurations for an HMD are described in greater detail in U.S. Patent Application Ser. No. 62/156,815 (filed May 4, 2015), the entirety of which is incorporated by reference herein. FIG. 6 (described below) also depicts an example configuration of the electronic display system of the HMD device 100.

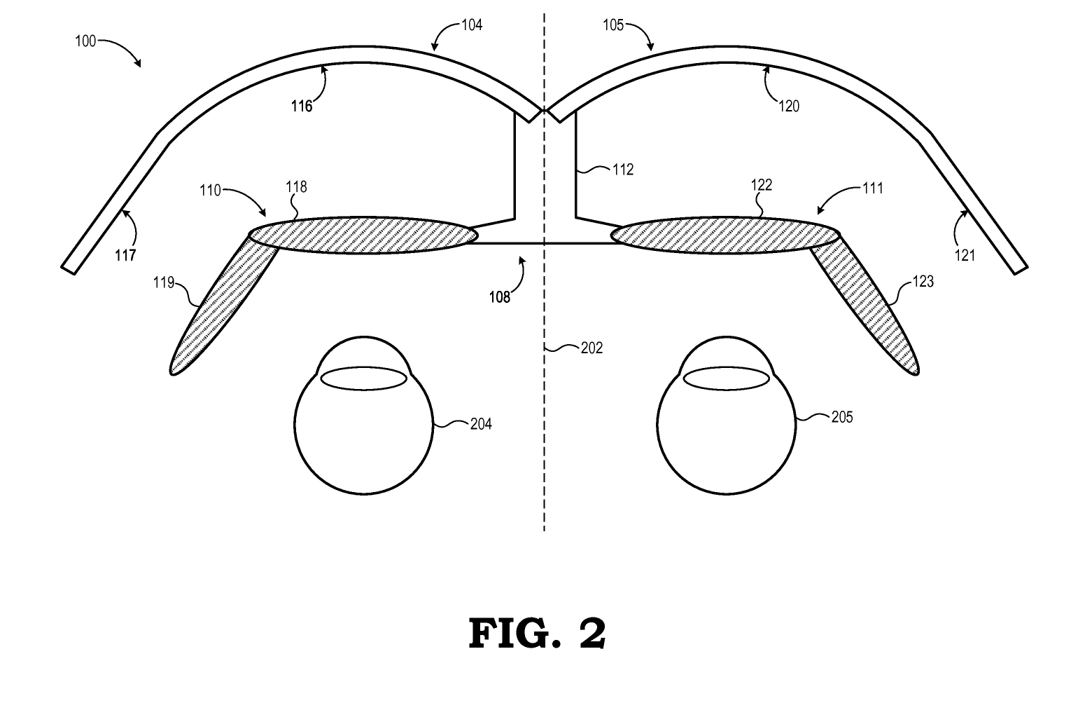

FIG. 2 illustrates a cross-section view of one example embodiment of the HMD device 100 along cut line A-A of FIG. 1 in accordance with at least one embodiment of the present disclosure. As shown, the HMD device 100 is substantially symmetric about a medial plane 202 that corresponds to the midsagittal plane of the user when wearing the HMD device 100. That is, the display panels 104, 105 and the optical subassemblies 110, 111 are arranged substantially symmetrically about the medial plane 202. The display panels 104, 105 are connected to the frame 106 via the bridge structure 112 such that a right-side edge of the display panel 104 is proximate to the left side of the medial plane 202 and a left-side edge of the display panel 105 is proximate to the right side of the medial plane 202. Likewise, in the depicted example, the bridge structure 112 serves to mount the optical subassemblies 110, 111 of the optical assembly 108 to the frame 106. Although not shown for ease of illustration, the frame 106 may include any of a variety of well-known mechanisms for adjusting the lateral positions of the optical subassemblies 110, 111 to fit the optical assembly 108 to the particular interpupillary distance (IPD) between the eyes 204, 205 of the user so as to reduce eye strain.

As explained above, the display panel 104 is mounted or otherwise disposed to the left of the medial plane 202 in the HMD device 100 such that the face of the display panel 104 forms a left central FOV section 116 and the left peripheral FOV section 117 and the display panel 105 likewise is mounted or otherwise disposed to the right of the medial plane such that the face of the display panel 105 forms the right central FOV section 120 and the right peripheral FOV section 121. Further, the cross-section view of FIG. 2 depicts the optical assembly 108 in greater detail, with the lenses 118, 119 focused on the FOV sections 116, 117 of the display panel 105, respectively, and serving to focus the imagery displayed on the display panel 104 into the left eye 204 of the user, and the lenses 122, 123 focused on the FOV sections 120, 121, respectively, and serving to focus the imagery displayed on the display panel 105 into the right eye 205 of the user. In at least one embodiment, the curvature of the central FOV sections 116, 120 allows the central FOV sections 116, 120 to better match with the field curvature of the corresponding magnifier lens 118, 122, respectively, and therefore facilitates the design of a wider field and a higher image-quality lens with a shorter focal length. Moreover, this curved configuration may provide for a central lateral FOV of 90 degrees or more.

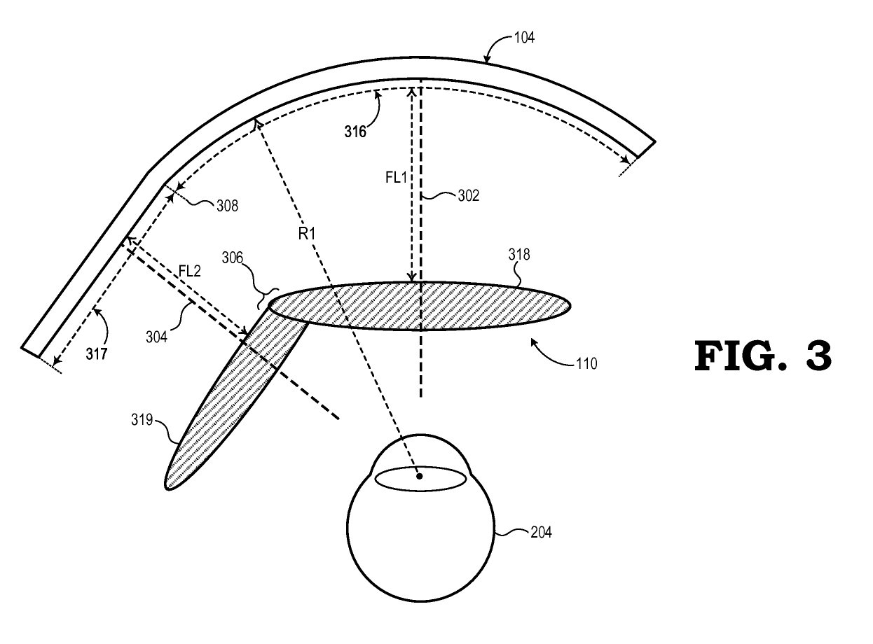

FIGS. 3-5 illustrate different example implementations for the display panel 104 and the optical subassembly 110, with the display panel 105 and optical subassembly 110 being similarly configured. Although each of these implementations depict the display panel 104 mounted or otherwise disposed so as to form two lateral sections and depict the optical subassembly 110 as having two corresponding lenses, the present disclosure is not limited to such implementations, but instead also may encompass configurations of the display panel arranged to form three or more lateral sections with distinct curvatures, relative orientations, or both, and with a commensurate number of optical elements in the corresponding optical subassembly, and each optical element may comprise a single lens or a group of lenses.

In the example implementation of FIG. 3, the display panel 104 is mounted in the HMD device 100 so as to form a central FOV section 316 (one example of central FOV section 116) and a peripheral FOV section 317 (one example of peripheral FOV section 117). The central FOV section 316 has, in this example, a substantially constant lateral curvature defined by a radius R1, and the peripheral FOV section 317 is substantially planar or flat. Further, in the depicted example, the optical subassembly 110 includes a convex lens 318 (one example of optical element 118) having an optical axis 302 normal to the facing surface of the central FOV section 316 and a convex lens 319 (one example of optical element 119) having an optical axis 304 normal to the facing surface of the peripheral FOV section 317. Further, in some embodiments, the lens 318 has a focal length FL1 that is substantially equal (that is, within +/−10%, or more preferably within +/−5%, and more preferably within +/−3%) to the focal length FL2 of the lens 319 so that at the boundary 308 of the transition between the FOV sections 316, 317 there is a similar pixel density and thus provides an easier transition for the user's eye. However, in other embodiments, the lenses may have different, or unequal, focus lengths.

Due to the dimensions and orientations of the FOV sections 316, 317 of the display panel 104, it may not be practical to use axi-symmetric or rotationally-symmetric (that is, “complete”) convex lenses for both lenses 318, 319. Accordingly, in some embodiments, one or both of the lenses 318, 319 may be laterally truncated (that is, rotationally or axially asymmetric) so as to facilitate a more compact lens subassembly configuration. Thus, as illustrated in FIG. 3, material on the proximal side of the lens 318 may be ground or otherwise removed so as to form the lens 318 as laterally asymmetric such that the proximal side of the lens 319 is truncated and shaped so as to conform with the curvature of the lens 318 in the region 306 of their contact. The lenses 318, 319 then may be fused together in this configuration so as to form a monolithic lens or optical element, or a mechanical structure may be used so as to maintain the lenses 318, 319 in their respective positions during use. By laterally truncating the lens 319, the centers of the lenses 318, 319 may be brought closer together, and thus permitting a more compact lens subassembly.

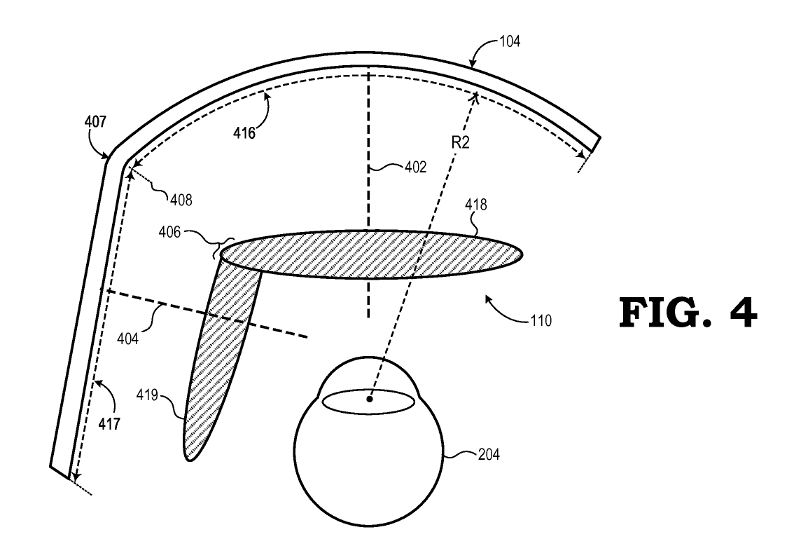

Turning to the example implementation of FIG. 4, in this example the display panel 104 is mounted in the HMD device 100 so as to form a central FOV section 416 (one example of central FOV section 116) and a peripheral FOV section 417 (one example of peripheral FOV section 117). The central FOV section 416 has, in this example, a substantially constant lateral curvature defined by a radius R2, and the peripheral FOV section 417 is substantially planar or flat. Further, the example of FIG. 4 differs from the example of FIG. 3 in that rather than have a relatively smooth transition between the central and peripheral FOV sections (as present in FIG. 3), the display panel 104 is mounted and arranged so that there is a sharp bend, or radius bend 407, in the transition 408 between the central FOV section 416 and the peripheral FOV section 417.

For this configuration, the optical subassembly 110 includes a convex lens 418 (one example of optical element 118) having an optical axis 402 normal to the facing surface of the central FOV section 416 and a convex lens 419 (one example of optical element 119) having an optical axis 404 normal to the facing surface of the peripheral FOV section 417. As with the implementation of FIG. 3, it may not be practical to use laterally-symmetric convex lenses for both lenses 418, 419, and thus one or both of the lenses 418, 419 may be laterally truncated so as to facilitate a more compact lens subassembly configuration. To illustrate, the proximal side of the lens 419 is truncated and shaped so as to conform with the curvature of the lens 318 in the region 406 of their contact, and then fused together or held in that arrangement using a mechanical assembly.

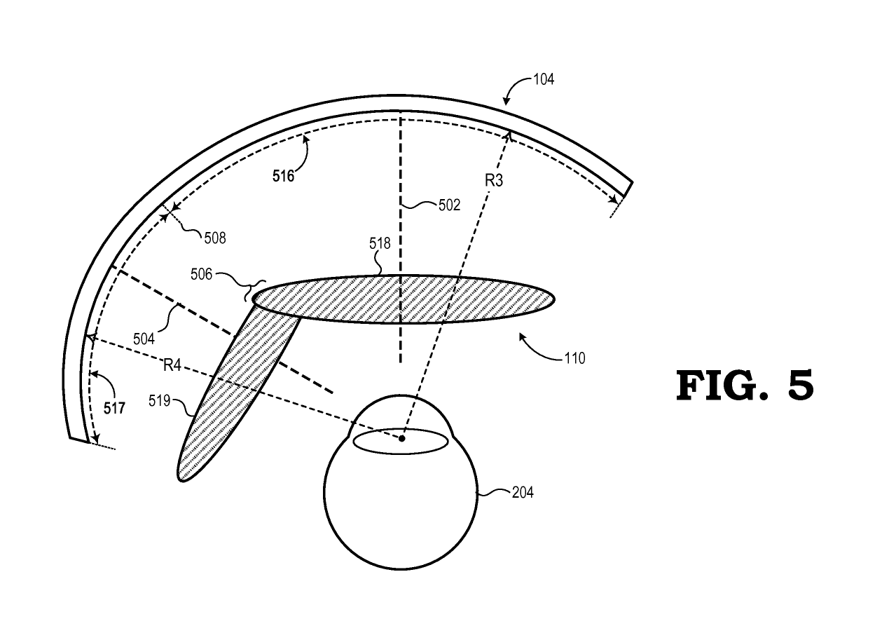

In the example implementation depicted in FIG. 5, the display panel 104 is mounted in the HMD device 100 so as to form a central FOV section 516 (one example of central FOV section 116) and a peripheral FOV section 517 (one example of peripheral FOV section 117), whereby the central FOV section 516 has a substantially constant lateral curvature defined by a radius R3, and the peripheral FOV section 517 likewise has a substantially constant curvature defined by a radius R4, which in the depicted embodiment the radius R3 is greater than the radius R4 (R3>R4). The transition between these two curvatures, and thus the transition from the FOV sections 516, 517, occurs at boundary 508.

For this configuration, the optical subassembly 110 includes a convex lens 518 (one example of optical element 118) having an optical axis 502 normal to the facing surface of the central FOV section 516 and a convex lens 519 (one example of optical element 119) having an optical axis 504 normal to the facing surface of the peripheral FOV section 517. One or both of the lenses 518, 519 may be laterally truncated so as to facilitate a more compact lens subassembly configuration. To illustrate, the proximal side of the lens 519 is truncated and shaped so as to conform with the curvature of the lens 518 in the region 506 of their contact, and then fused together or held in that arrangement using a mechanical assembly.

FIG. 6 illustrates an example hardware configuration of an electronic display system 600 of the HMD device 100 in accordance with at least one embodiment of the present disclosure. As noted above, the HMD device 100 may be used in association with the execution of a VR or AR application (referred to herein as “VR/AR application 602”) so as to render stereoscopic VR or AR content representing scenes from current poses of the user's head or the HMD device 100, the VR or AR content comprising a sequence of textures for each eye.

In the depicted example, the electronic display system 600 includes an application processor 604, a system memory 606, a sensor hub 608, and an inertial management unit 610. In some embodiments, the HMD device 100 may incorporate image capture for purposes of visual localization or visual telemetry, or for real-time display of imagery captured of the local environment in support of AR functionality. In such embodiments, the electronic display system 600 further may include, for example, one or more image sensors 612, 614 and a structured-light or time-of-flight (ToF) depth sensor 616.

The electronic display system 600 further includes display hardware 622 including a compositor 624, the left-eye display panel 104, the right-eye display panel 105, and a display memory 626. The compositor 624 is a hardware device that may be implemented as, for example, an ASIC, programmable logic, or a combination thereof, and includes a left display controller 628 for driving the left eye display panel 104 and a right display controller 630 for driving the right eye display panel 105.

In operation, the application processor 604 executes the VR/AR application 602 (stored in, for example, the system memory 606) to provide VR/AR functionality for a user. As part of this process, the VR/AR application 602 manipulates the application processor 604 to render a sequence of textures (or pictures) for each eye at a render rate X. Each texture contains visual content that is either entirely computer generated or visual content that is a combination of captured imagery (via the imaging sensors 612, 614) and a computer-generated overlay. The visual content of each texture represents a scene from a corresponding pose of the user's head (or pose of the HMD device 100) at the time that the texture is determined.

Optical lenses, such as those of the optical assembly 108, typically introduce some form of spatial distortion, such as barrel distortion, pincushion distortion, or complex distortion (also referred to as “moustache distortion”). Conventionally, display systems can at least partially correct for these spatial distortions by performing one or more warp transforms on each buffered image so as to compensate for the spatial distortion either present in the buffered image or that will be introduced when the buffered image is viewed through the lenses in an eyepiece.

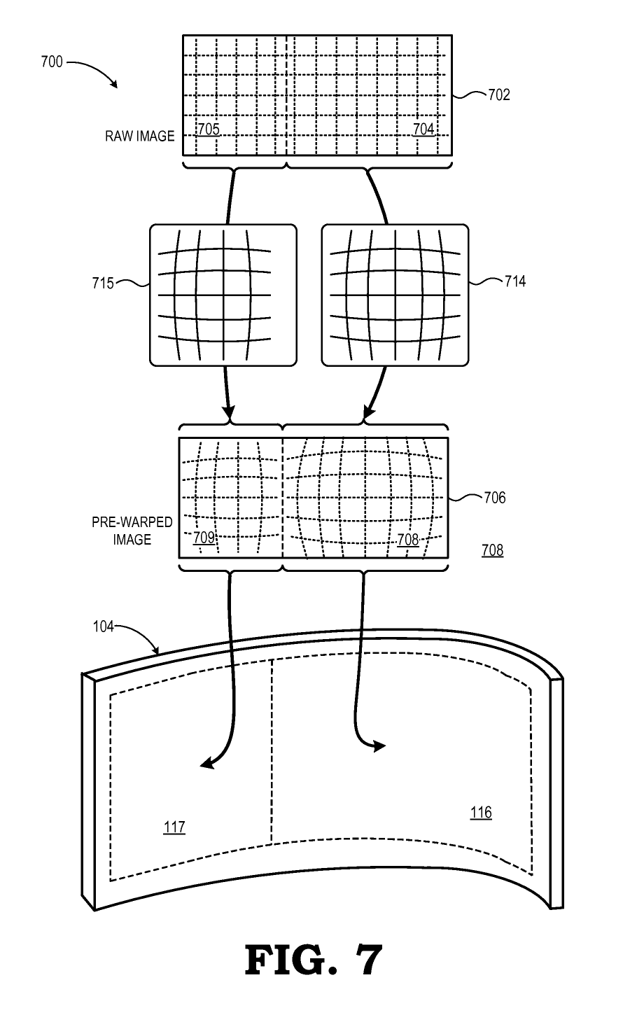

Accordingly, in some embodiments, the electronic display system 600 may operate to introduce a complementary spatial distortion into the textures as they are displayed (that is, “pre-warp” the textures) so as to correct or compensate for the spatial distortion introduced by the lenses of the optical assembly 108, and thus the imagery presented to the user's eyes is perceived as substantially rectilinear. In some embodiments, this pre-warp process may be performed by the compositor 624 (with each of the left side and right side textures receiving separate pre-warping). In other embodiments, the pre-warp process may be implemented by the rendering algorithm of the VR/AR application 602. Because each of the display panels 104, 105 implements two or more different “sections” and the optical assembly 108 implements a different optical element for each section, in at least one embodiment the electronic display system 600 is configured to implement a different spatial distortion map for each lateral section of a display panel. This process is illustrated in greater detail with reference to FIG. 7 below.

FIG. 7 depicts an example pre-warp process 700 implemented by the electronic display system 600 of FIG. 6 in accordance with at least one embodiment of the present disclosure. Initially, the VR/AR application 602 renders a raw image 702 to be displayed at one of the display panels 104, 105. The raw image 702 includes a plurality of rows of pixels that span across two lateral sections 704, 705 (with the boundary between the two indicated by dashed line 706). Assuming the raw image 702 is generated for display on the display panel 104, the lateral section 704 represents the image content to be displayed on the central FOV section 116 and the lateral section 705 represents the image content to be displayed on the peripheral FOV section 117.

With the generation of the raw image 702, the electronic display system 600 then pre-distorts the raw image 702 to compensate for the complementary distortion that will be introduced by the lenses 118, 119 when the image is displayed and viewed through the lenses 118, 119. However, the lenses 118, 119 typically are not of the same configuration and thus typically do not introduce the same spatial distortion. To illustrate, the lenses 118, 119, may be of a different magnification or prescription, a different focal length, and the like. As such, the degree and type of distortion introduced by each lens may differ. Further, as noted above, one or both of the lenses 118, 119 may be laterally truncated (that is, rotationally or axially asymmetric) so as to permit a more compact assembly for the lenses 118, 119. This truncated configuration for a lens also may be a factor in the particular pre-warping to be applied to the corresponding image content.

As such, in at least one embodiment, the electronic display system 600 employs different spatial distortion maps for each section, with each spatial distortion map being configured for the particular arrangement of lateral display panel section and lens. For the lateral section 704, the electronic display system 600 employs a spatial distortion map 714 that is configured based on the curvature of the central FOV section 116, the magnification and anticipated distortion introduced by the lens 118, and the like. To illustrate, if the lens 118 is expected to introduce a pin-cushion distortion, the spatial distortion map 714 may introduce a compensatory barrel distortion, with the particular parameters of the barrel distortion determined from the parameters of the lens 118, the central FOV section 116, and the like. Likewise, for the lateral section 705, the electronic display system 600 employs a different spatial distortion map 715 that is configured based on the curvature (or lack thereof) of the peripheral FOV section 117, the magnification and anticipated distortion introduced by the lens 119, and the like. To illustrate, because the lens 119 is a laterally-truncated or laterally-asymmetrical lens, the spatial distortion map 715 configured for the lateral section 705 may be similarly truncated or asymmetrical.

The electronic display system 600 applies the spatial distortion maps 714, 715 to the lateral sections 704, 705, respectively, of the raw image 702 to generate a pre-warped image 706. The pre-warped image 706 is then used by the left display controller 628 to drive the left display panel 104 such that the pre-warped image 706 is displayed at the display panel 104 with the image content of a lateral section 708 of the pre-warped image 706 displayed in the region represented by the central FOV section 116 and the image content of a lateral section 709 of the pre-warped image 706 displayed in the region represented by the peripheral FOV section 117. With the pre-warped image 706 so displayed, when viewed by the user through the corresponding optical elements of the HMD 100, the spatial distortion introduced into the displayed image 706 via the spatial distortion maps 714, 715 partially or completely counteracts, or complements, the spatial distortion introduced by the optical elements of the HMD 100, thereby presenting a continuously undistorted, substantially rectilinear image to the user's eye.

Much of the inventive functionality and many of the inventive principles described above are well suited for implementation with or in integrated circuits (ICs) such as application specific ICs (ASICs). It is expected that one of ordinary skill, notwithstanding possibly significant effort and many design choices motivated by, for example, available time, current technology, and economic considerations, when guided by the concepts and principles disclosed herein will be readily capable of generating such ICs with minimal experimentation. Therefore, in the interest of brevity and minimization of any risk of obscuring the principles and concepts according to the present disclosure, further discussion of such software and ICs, if any, will be limited to the essentials with respect to the principles and concepts within the preferred embodiments.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A head mounted display (HMD) device comprising:
first and second display panels laterally disposed about a medial plane, wherein each of the first and second display panels includes a first lateral section and an adjacent second lateral section, the first lateral section adjacent to the medial plane and the second lateral section distal from the medial plane; and
an optics assembly comprising first and second optics subassemblies laterally disposed about the medial plane, wherein each of the first and second optics subassemblies includes a first optical element having an optical axis that intersects the first lateral section of a corresponding one of the first and second display panels and a second optical element having an optical axis that intersects the second lateral section of the corresponding one of the first and second display panels.

2. The HMD device of claim 1, wherein:
the first lateral section has a curvature with a first radius; and
the second lateral section has a curvature with a second radius different than the first radius.

3. The HMD device of claim 2, wherein:
the second radius is less than the first radius.

4. The HMD device of claim 2, wherein:
each of the first and second display panels includes a radius bend between the first lateral section and the second lateral section.

5. The HMD device of claim 1, wherein:
the first lateral section has a lateral curvature; and
the second lateral section is substantially planar.

6. The HMD device of claim 5, wherein:
each of the first and second display panels includes a radius bend between the first lateral section and the second lateral section.

7. The HMD device of claim 1, wherein:
the optical axis of the first optical element is normal to a facing surface of the first lateral section of the corresponding one of the first and second display panels.

8. The HMD device of claim 7, wherein the optical axis of the second optical element is normal to a facing surface of the second lateral section of the corresponding one of the first and second display panels.

9. The HMD device of claim 1, wherein:
the first optical element is rotationally symmetric; and
the second optical element is t asymmetric.

10. The HMD device of claim 9, wherein:
the first optical element and the second optical element have substantially equal focal lengths.

11. The HMD device of claim 9, wherein:
the first optical element and second optical element form a monolithic optical element.

12. The HMD device of claim 1, wherein:
the first lateral section and the corresponding first optical element provide a lateral field of view of at least 90 degrees.

13. The HMD device of claim 1, wherein:
the first and second display panels are operated to present stereoscopic virtual reality imagery.

14. The HMD device of claim 1, wherein:
the first and second display panels are operated to present stereoscopic augmented reality imagery.

15. A method comprising:
providing a head mounted display (HMD) device comprising first and second display panels laterally disposed about a medial plane and an optics assembly comprising first and second optics subassemblies laterally disposed about the medial plane, wherein each of the first and second display panels includes a first lateral section adjacent to the medial plane and a second lateral section distal from the medial plane, and wherein each of the first and second optics subassemblies includes a first optical element having an optical axis that intersects the first lateral section of a corresponding one of the first and second display panels and a second optical element having an optical axis that intersects the second lateral section of the corresponding one of the first and second display panels;
displaying first imagery at the first display panel; and
displaying second imagery at the second display panel.

16. The method of claim 15, wherein:
providing the HMD device comprises providing the HMD device such that the first lateral section has a curvature with a first radius and the second lateral section has a curvature with a second radius different than the first radius.

17. The method of claim 15, wherein:
providing the HMD device comprises providing the HMD device such that the first lateral section has a curvature and the second lateral section is substantially planar.

18. The method of claim 15, wherein:
providing the HMD device comprises providing the HMD device such that the first optical element is rotationally symmetric and the second optical element is rotationally asymmetric.

19. The method of claim 15, wherein displaying first imagery at the first display panel comprises:
generating a raw rectilinear image;
pre-warping the raw rectilinear image to generate a pre-distorted rectilinear image; and
displaying the pre-distorted rectilinear image on the first display panel, the pre-distorted rectilinear image spanning both the first and second lateral sections of the first display panel.

20. The method of claim 19, wherein pre-warping the raw rectilinear image comprises:
spatially distorting a section of the raw rectilinear image to be displayed on the first lateral section using a first distortion map to generate a first section of the pre-distorted rectilinear image; and
spatially distorting a section of the raw rectilinear image to be displayed on the second lateral section using a second distortion map to generate a second section of the pre-distorted rectilinear image, the second distortion map different than the first distortion map.
